(19) United States
(12) Patent Application Publication
(10) Pub. No.: US 2026/0361640 A1
(43) Pub. Date: Nov. 12, 2026

(54) SYSTEM FOR ENHANCING DATA TRANSMISSION BETWEEN BIOS AND PERIPHERAL DEVICES

(71) Applicant: Aivres Systems Inc., San Jose, CA (US)

(72) Inventor: Wangbin ZHENG, Taipei (TW)

(21) Appl. No.: 19/202,538

(22) Filed: May 8, 2025

(51) Int. Cl. H04L 45/00; G06F 9/4401

(52) U.S. Cl. CPC H04L 45/22; G06F 9/4401

(57) ABSTRACT

The invention provides a system for enhancing data transmission efficiency and stability between a server's Basic Input/Output System (BIOS) and peripheral devices. The system includes a processor configured to execute BIOS instructions stored in memory, a data transmission module integrated with the BIOS and preconfigured with the Non-Volatile Memory Express over Fabrics (NVMe-oF) protocol for data communication over a network fabric, and a dynamic path adjustment module. The data transmission module replaces or supplements the traditional Peripheral Component Interconnect Express (PCIe) protocol, enabling low-latency, high-bandwidth communication between the BIOS and peripheral devices. The dynamic path adjustment module monitors real-time performance metrics, such as bandwidth utilization and latency, and dynamically optimizes data transmission paths to ensure efficient and reliable communication.

### TECHNICAL FIELD

This invention relates to the field of server technologies, particularly to methods and systems for optimizing data transmission between a server's Basic Input/Output System (BIOS) and hardware devices during the boot process.

### BACKGROUND

With the rapid advancement of server technology, servers have become an integral part of modern computing environments, ranging from data centers to cloud computing infrastructures. As the number and complexity of hardware devices connected to servers have grown, the demand for higher performance, faster response times, and reliable operations has also increased. During the startup process, the server's BIOS plays a critical role in initializing hardware and configuring the system. However, traditional data transmission methods, such as PCIe channels, are increasingly inadequate to meet the performance requirements of high-performance servers.

Specifically, traditional data transmission approaches face several challenges, including low data transfer rates, high latency due to complex transmission paths with multiple relay nodes, and a lack of mechanisms to dynamically adjust transmission paths or predict potential faults. These issues result in slow server startup speeds, operational instability, and increased risks of system crashes.

To address these challenges, there is a pressing need for a novel solution that not only enhances data transmission efficiency between the BIOS and hardware devices but also ensures stability, adaptability, and fault resilience during the startup process.

### SUMMARY

A system comprising one or more computers can be configured to perform specific operations or actions by utilizing software, firmware, hardware, or a combination thereof. When operational, these components cause the system to execute the desired actions. Similarly, one or more computer programs can be configured to perform particular operations or actions by including instructions that, when executed by data processing apparatus, enable the apparatus to perform the specified actions.

In one general aspect, the system includes a processor configured to execute BIOS instructions stored in memory. The system also includes a data transmission module integrated with the BIOS and preconfigured with a Non-Volatile Memory Express over Fabrics (NVMe-oF) protocol. In some embodiments, the system may refer to software components, firmware components, or a combination of both associated with the BIOS.

The data transmission module facilitates data communication between the BIOS and peripheral devices over data transmission paths within a network fabric. Additionally, the system incorporates a dynamic path adjustment mechanism that uses the NVMe-oF protocol to monitor real-time performance metrics of the data transmission paths and dynamically adjust these paths to maintain efficiency and reliability. Furthermore, the system supports replacing or supplementing the traditional Peripheral Component Interconnect Express (PCIe) protocol with the NVMe-oF protocol for data communication between the BIOS and peripheral devices. Other embodiments of this system include corresponding computer systems, apparatus, and computer programs recorded on one or more computer storage devices, each configured to perform the described actions.

The implementations may include one or more of the following features:

The system may utilize the NVMe-oF protocol with a Remote Direct Memory Access (RDMA) transport protocol, enabling low-latency and high-bandwidth communication between the BIOS and peripheral devices. The system may also include functionality where the dynamic path adjustment mechanism reroutes data transmission to an alternate path when it detects performance degradation or faults in the current path.

Additionally, the system may incorporate a degradation prediction feature that feeds historical performance metrics of data transmission paths into a machine learning model to learn performance trajectories. The model can generate predicted scores for potential degradation and, based on these scores, trigger preventive actions to mitigate data transmission failures. These preventive actions may include generating alerts for maintenance personnel, instructing the addition of redundant devices to high-risk hardware components, or proactively switching to alternate data paths.

The data transmission module may also be configured to select an optimal protocol from a predefined set of protocols, including NVMe-oF and PCIe, based on the performance requirements and operating environment of the peripheral device. Furthermore, the BIOS may perform bus scans to identify connected hardware devices, such as CPUs, memory, storage devices, and network interface cards. It may load appropriate device drivers from firmware based on the identified device types and configure operational parameters, including memory clock frequencies and storage device read/write modes.

Real-time performance metrics of data transmission paths may include bandwidth utilization, transmission latency, and packet loss rates. The system may also include a firmware loading feature that allows it to load and execute firmware for peripheral devices using the NVMe-oF protocol during the server startup process. Moreover, the dynamic path adjustment mechanism may analyze data transmission paths to identify performance bottlenecks and redundant relay nodes. Using Software-Defined Networking (SDN), the system can reconstruct these paths to optimize data transmission efficiency by removing redundant nodes.

Implementations of these described techniques may involve hardware, methods or processes, or tangible computer-readable media.

In another general aspect, a method may include executing BIOS instructions on a processor to initialize and configure peripheral devices. The method may also include implementing the NVMe-oF protocol within a data transmission module integrated with the BIOS to facilitate data communication between the BIOS and peripheral devices over a network fabric. Additionally, the method may include monitoring real-time performance metrics of data transmission paths using a dynamic path adjustment mechanism and dynamically adjusting the paths based on the monitored metrics. Furthermore, the method may include replacing or supplementing the PCIe protocol in the data transmission module with the NVMe-oF protocol to enhance communication efficiency and scalability. Other embodiments of this method include corresponding computer systems, apparatus, and computer programs recorded on one or more computer storage devices, each configured to perform the described actions.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 illustrates example processes of a Basic Input/Output System (BIOS) during the system startup sequence.

FIG. 2 illustrates example functions of a BIOS and limitations of existing BIOS configuration.

FIG. 3 illustrates an example BIOS configured with a Non-Volatile Memory Express over Fabrics (NVMe-oF) protocol for data transmission, in accordance with one embodiment.

FIG. 4 illustrates an example BIOS supporting dynamic and proactive adjustment of data transmission paths, in accordance with one embodiment.

FIG. 5 illustrates a method of enhancing data transmission efficiency and stability between a server BIOS and peripheral devices, in accordance with one embodiment.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

As explained in the background section, traditional data transmission methods such as PCIe channels are increasingly unable to meet the demands of modern high-performance servers, leading to challenges such as slow startup speeds, operational instability, and increased risks of system crashes. During server startup, the BIOS plays a critical role in initializing and configuring peripheral devices. The CPU, guided by the BIOS, executes instructions to allocate system resources, set up communication pathways, and ensure proper device functionality. However, the limitations of PCIe in scalability, flexibility, and fault tolerance hinder the BIOS's ability to efficiently manage the growing complexity of server hardware.

This invention introduces a novel mechanism to replace or supplement PCIe with NVMe over Fabrics (NVMe-oF), a protocol designed to extend NVMe's high-performance capabilities to networked environments. By leveraging transport protocols such as RDMA (Remote Direct Memory Access) or TCP, NVMe-oF enables the BIOS to interact with remote devices over high-speed network fabrics, providing near-local performance. Unlike PCIe, which is confined to direct, local connections, NVMe-oF facilitates communication across distributed systems, enabling greater scalability and resource sharing.

The integration of NVMe-oF into the BIOS offers several key benefits. First, it significantly enhances data transmission efficiency by providing high bandwidth and low latency. This allows the BIOS to initialize and configure peripheral devices more quickly, reducing server startup times. Second, NVMe-oF supports dynamic path adjustments and fault-tolerant mechanisms, ensuring continuous and reliable operation even in the event of path congestion or device failures. Third, the networked architecture of NVMe-oF enables better fault isolation, minimizing the impact of hardware issues and improving overall system resilience.

Additionally, the invention incorporates advanced fault or degradation prediction and prevention mechanisms. By utilizing machine learning algorithms to analyze historical data, the system identifies patterns that may indicate potential failures in data transmission. This allows the BIOS to proactively address issues before they disrupt operations, reducing downtime and maintenance costs.

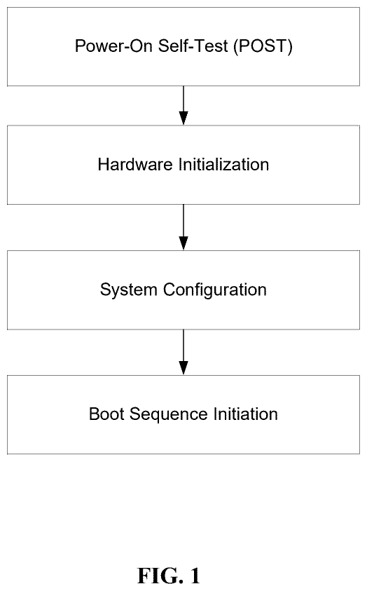

FIG. 1 illustrates example processes of a Basic Input/Output System (BIOS) during the system startup sequence. The illustrated processes include four main steps in the startup process: power-on self-test (POST), hardware initialization, system configuration, and boot sequence initiation.

During the first step, the BIOS conducts a Power-On Self-Test (POST) immediately after the computer is powered on. This diagnostic phase ensures that essential hardware components are functioning properly. The BIOS verifies the operational status of the CPU, RAM, and storage devices, checks the integrity of the BIOS firmware itself, and tests other critical hardware components, including the keyboard, display adapter, and system timer. If the BIOS detects any issues during POST, it generates error messages, which may be presented as beep codes or on-screen text, enabling early identification and resolution of potential hardware problems.

After successfully completing POST, the BIOS transitions to hardware initialization. In this step, the BIOS initializes various hardware components to prepare them for operation. For example, system memory is configured and mapped to specific addresses, and interrupt handlers and device drivers are set up to enable communication between hardware and software. Video cards are initialized, while input devices such as keyboards and mice are detected and configured. The BIOS also identifies and initializes PCI devices and other expansion cards to ensure that all connected hardware is ready for use.

Following hardware initialization, the BIOS proceeds to system configuration. During this phase, the BIOS applies system settings stored in Complementary Metal-Oxide-Semiconductor (CMOS) memory, such as hardware configurations and user-defined preferences. The system clock is set, power management features are configured, and other parameters are applied to ensure the system operates according to the desired configurations. This phase ensures that both hardware and system-level settings are synchronized before transitioning to the boot process.

In the final step, the BIOS initiates the boot sequence. It identifies bootable devices based on the boot order specified in the BIOS settings, such as hard drives, USB devices, or network drives. The BIOS then loads the bootloader from the selected boot device and transfers control to the bootloader, which is responsible for loading the operating system. This step completes the startup sequence, enabling the computer to transition from hardware initialization to full system operation.

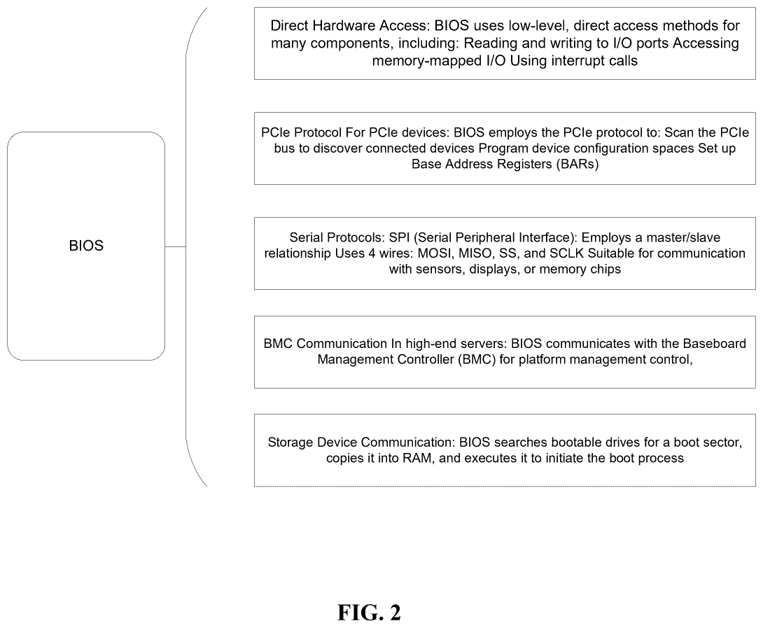

FIG. 2 illustrates example functions of a BIOS and limitations of existing BIOS configuration, including the critical role of the BIOS in facilitating communication and initialization processes during server startup, as well as the challenges posed by traditional data transmission methods such as PCIe.

Throughout the server startup process, the CPU executes BIOS instructions to initialize and configure hardware components. The BIOS employs a multi-faceted approach to prepare the system hardware before handing control to the operating system. This process includes direct hardware access, where the BIOS uses low-level methods such as reading and writing to I/O ports, accessing memory-mapped I/O, and using interrupt calls to manage communication with peripheral devices. For example, the BIOS uses serial protocols like the Serial Peripheral Interface (SPI), which operates in a master/slave configuration with four wires (MOSI, MISO, SS, and SCLK), enabling communication with sensors, displays, or memory chips. In high-end servers, the BIOS also communicates with the Baseboard Management Controller (BMC) to perform platform management tasks. Furthermore, the BIOS interacts with storage devices by searching for bootable drives, loading the boot sector into RAM, and executing it to initiate the boot process.

Despite these essential functions, the PCIe protocol used by the BIOS for data communication imposes limitations in modern high-performance servers. PCIe, while effective for local, direct-attached communication between the CPU and peripheral devices, suffers from scalability constraints. As the number and complexity of devices connected to servers increase, the fixed number of PCIe lanes and slots limits its ability to accommodate the growing hardware demands. This is particularly challenging in large-scale data centers and distributed computing environments, where the need for scalability is paramount.

In addition, PCIe may have bandwidth bottlenecks. While PCIe offers high bandwidth, its capacity becomes a bottleneck as the volume of data transmission increases, especially in workloads such as big data analytics, machine learning, and high-performance computing. The inability to handle the rising data demands leads to slower communication and reduced performance. Additionally, contention for limited PCIe lanes causes congestion, resulting in increased latency, particularly during the server startup process, when the BIOS must efficiently communicate with an increasing number of peripheral devices.

Another limitation of PCIe is its lack of flexibility. The protocol is confined to local, physical connections within the system, making it difficult to dynamically reconfigure or share resources across systems. This rigidity poses a significant disadvantage in cloud computing and virtualized environments, where dynamic resource allocation and optimization are critical. Moreover, PCIe's tight coupling between the CPU and devices creates vulnerabilities to single points of failure. A fault in a device or communication pathway can disrupt the entire system, making PCIe ill-suited for modern high-performance servers that require robust fault tolerance under heavy workloads and adverse conditions.

To address these challenges, this disclosure introduces a BIOS configuration network-based alternative data transmission protocols, such as Non-Volatile Memory Express over Fabrics (NVMe-oF). NVMe-oF extends high-performance data communication over network fabrics, enabling remote access to NVMe devices with near-local performance. NVMe-oF provides greater scalability, allowing the BIOS to efficiently handle an increasing number of peripheral devices across distributed systems. It also delivers higher flexibility by supporting dynamic resource sharing and reconfiguration, which are essential for cloud and virtualized environments. Furthermore, NVMe-oF enhances fault tolerance by decoupling devices from the local system architecture, reducing the risk of system-wide disruptions.

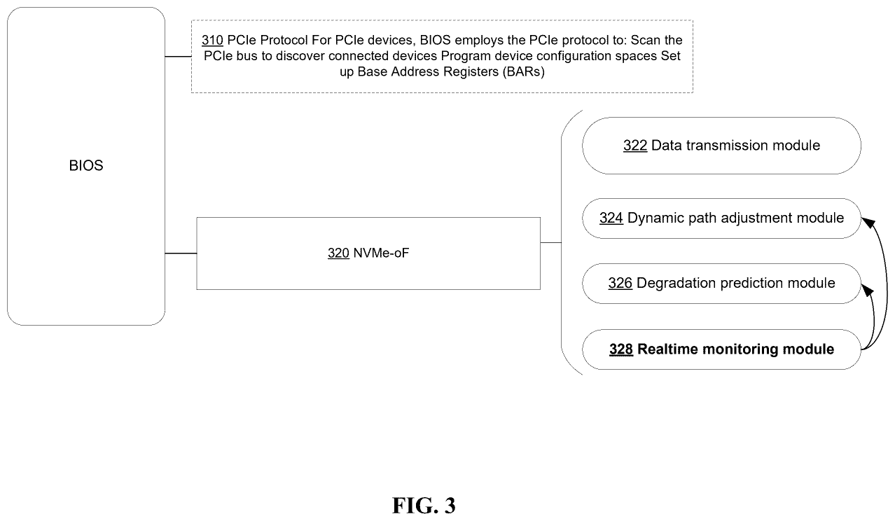

FIG. 3 illustrates an example BIOS configured with a Non-Volatile Memory Express over Fabrics (NVMe-oF) protocol for data transmission, in accordance with one embodiment.

As shown in FIG. 3, the BIOS integrates several modules to support NVMe-oF protocol 320 for enhanced data transmission. These modules include a data transmission module 322, a dynamic path adjustment module 324, a degradation prediction module 326, and a real-time monitoring module 328.

In some embodiments, the data transmission module 322 may be implemented by a firmware within the BIOS to establish NVMe-oF communication between the BIOS and peripheral devices before the operating system loads. By integrating low-level drivers and network protocol handling, the data transmission module 322 enables the BIOS to detect and communicate with remote storage devices in early boot stages. Once the operating system (OS) takes over, higher-level software drivers may manage more advanced NVMe-oF features.

The dynamic path adjustment module 324, degradation prediction module 326, and real-time monitoring module 328 may be implemented by a mix of firmware and software. While the BIOS collects performance metrics and performs initial data path optimizations, more computationally intensive tasks, such as machine learning-based degradation prediction, may shift to the operating system or a software-based management controller.

In some embodiments, the data transmission module 322 is preconfigured with the NVMe-oF protocol to enable high-performance communication between the BIOS and peripheral devices over a network fabric. Unlike the PCIe protocol 310, which is limited to direct, local connections, the NVMe-oF protocol 320 leverages transport methods such as Remote Direct Memory Access (RDMA). RDMA allows the BIOS to communicate with peripheral devices with minimal latency and high bandwidth, making it well-suited for modern server environments.

In some embodiments, the BIOS may support both PCIe protocol 310 and NVMe-oF protocol 320 (potentially other suitable protocols), and the data transmission module 322 may be configured to select an optimal protocol from the predefined set of protocols based on the performance requirements of a peripheral device and the operating environment. For example, during server startup, if a locally attached high-speed NVMe SSD is detected, the data transmission module may select the PCIe protocol to leverage its direct-attached, low-latency characteristics. Conversely, if the peripheral device is a remote NVMe storage array located across a data center, the module may select the NVMe-oF protocol to take advantage of its ability to maintain high bandwidth and low latency over a network fabric, such as one using RDMA. Similarly, in hybrid environments where both high-performance and legacy devices coexist, the BIOS may select the protocol most compatible with each device, ensuring efficient and reliable communication tailored to the system's workload and infrastructure.

In some embodiments, the dynamic path adjustment module 324 in configured to monitor real-time performance metrics of the data transmission paths obtained by the real-time monitoring module 328, such as bandwidth utilization, latency, and packet loss rates. When performance bottlenecks or redundant relay nodes are detected, the dynamic path adjustment module 324 may reconstruct, using Software-Defined Networking (SDN), the paths to optimize efficiency by removing unnecessary nodes.

In some embodiments, a performance degradation or fault may be detected in a current data transmission path based on the real-time performance metrics of the data transmission paths obtained by the real-time monitoring module 328. In response, the dynamic path adjustment module reroutes the data transmission to an alternate path within the network fabric. For example, if a bottleneck is identified on a path segment due to high traffic or hardware issues, the module dynamically selects a less-congested route, ensuring uninterrupted and efficient communication. This capability significantly reduces the risks of system crashes or delays during the BIOS's initialization processes.

In some embodiments, the degradation prediction module 326 works in tandem with the dynamic path adjustment module 324 to proactively identify and mitigate potential failures. This degradation prediction module 326 utilizes historical performance metrics from the data transmission paths and feeds them into a machine learning model to learn performance trajectories. The model generates predicted scores for performance degradation, allowing the system to anticipate risks before they materialize. Based on the predicted scores, the degradation prediction module 326 may further determine preventive actions to mitigate the risk of data transmission failures. For instance, the degradation prediction module 326 may alert maintenance personnel about high-risk segments, recommend adding redundant devices to mitigate hardware failure risks, or instruct the dynamic path adjustment module to preemptively switch to an alternate data path.

The real-time monitoring module 328 complements these functions by continuously collecting performance metrics from the network fabric. This module is implemented using hardware or software-based monitoring agents that operate within the BIOS to actively track key performance indicators (KPIs) of data transmission paths. These KPIs include bandwidth utilization, transmission latency, packet loss rates, and error rates across individual segments of the network fabric. The real-time monitoring module leverages system-level APIs or firmware-based hooks to interface with the network fabric and peripheral devices, ensuring minimal overhead during data collection.

To maintain up-to-date data, the module samples performance metrics at regular intervals, with configurable polling rates depending on the network's complexity and traffic conditions. For instance, if the module detects a sudden spike in latency or an increase in packet loss along a particular path, it triggers an alert to the dynamic path adjustment module to initiate rerouting.

In some embodiments, the system also includes a firmware loading module (not shown in FIG. 3) integrated with the data transmission module 322. This module is configured to load and execute firmware for peripheral devices using the NVMe-oF protocol during the server startup process. The use of NVMe-oF for firmware loading improves both speed and reliability compared to PCIe, enabling faster initialization of hardware components and reducing server startup times.

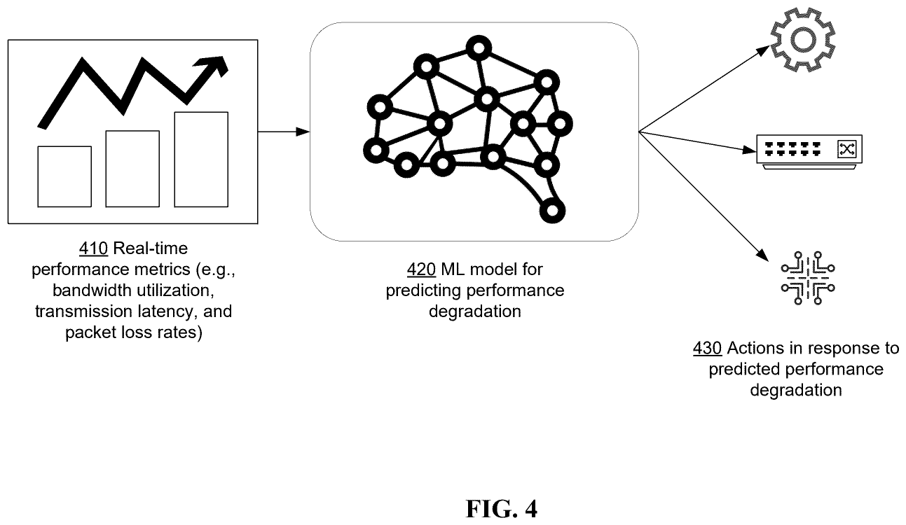

FIG. 4 illustrates an example BIOS supporting dynamic and proactive adjustment of data transmission paths, in accordance with one embodiment. In this configuration, the BIOS collects real-time performance metrics 410, such as bandwidth utilization, transmission latency, and packet loss rates, from the network fabric. These metrics are recorded alongside historical performance data, for identifying potential data transmission bottlenecks or points of failure before they can disrupt system operations.

As shown in FIG. 4, the machine learning model 420 leverages both real-time and historical performance metrics to learn performance trajectories for the various data transmission paths. In some embodiments, the training process for the machine learning model 420 involves collecting large volumes of performance data from similar network fabric, including metrics such as bandwidth utilization, transmission latency, and packet loss rates. This data is preprocessed to remove noise and normalize values, ensuring consistency across different operating conditions. Features such as time-series trends, peak utilization patterns, and anomaly indicators are extracted from the data to serve as inputs to the model 420. The model 420, which may employ algorithms like recurrent neural networks (RNNs), is trained to recognize patterns that correspond to stable operations versus those that precede performance degradation or data path faults.

During training, the model 420 is validated against labeled datasets where past instances of performance degradation or faults have been annotated. For example, if a particular data transmission path experienced latency spikes before packet loss occurred, these events are tagged to allow the model 420 to associate such patterns with potential failures. The training process includes iterative optimization using loss functions designed to minimize false positives and false negatives, ensuring the model can accurately predict degradation without unnecessary alarms. Over time, the model 420 becomes capable of generating predicted scores for each data transmission path, quantifying the likelihood of performance degradation under current and predicted future conditions.

When the machine learning model 420 generates a predicted score that exceeds a preset threshold, the system triggers preventive actions 430 to mitigate potential data transmission failures. For instance, consider a server in a data center initializing its connected NVMe storage device using the NVMe-oF protocol. The BIOS communicates with the remote NVMe storage device over a network fabric composed of interconnected switches, following an initial path such as Switch A→Switch B→Switch C→NVMe storage device. The system continuously monitors real-time performance metrics, such as bandwidth utilization, latency, and packet loss rates, along this path.

If the machine learning model 420 predicts a high likelihood of latency buildup or packet loss between Switch B and Switch C, it identifies this segment as a bottleneck. For example, the increased latency may result from high traffic due to concurrent transmissions from other data paths accessing the same network fabric. To mitigate this, the system proactively reroutes the data transmission to an alternate path, such as Switch A→Switch D→Switch E→NVMe storage device, bypassing the congested segment. This rerouting ensures that the data transmission avoids the predicted bottleneck, maintaining stable and efficient communication.

In another scenario, if the machine learning model 420 predicts that packet loss rates are likely to escalate due to hardware degradation in Switch C, the system may generate an alert to notify maintenance personnel. The alert could specify the affected switch (Switch C), the predicted metrics indicating degradation (e.g., increased error rates or reduced throughput), and suggested corrective actions, such as inspecting or replacing the switch.

If the predicted scores indicate a recurring risk at a specific node, such as Switch C, the system might instruct the deployment of additional hardware to address the issue. For instance, the system may recommend adding a redundant relay node (Switch F) to distribute the traffic load or creating a new alternate connection path to alleviate stress on Switch C. Similarly, if a specific storage device is flagged as high-risk due to bandwidth saturation or elevated error rates, the system could preemptively redistribute traffic to other available NVMe storage devices within the fabric, such as rerouting to a storage device connected via Switch G.

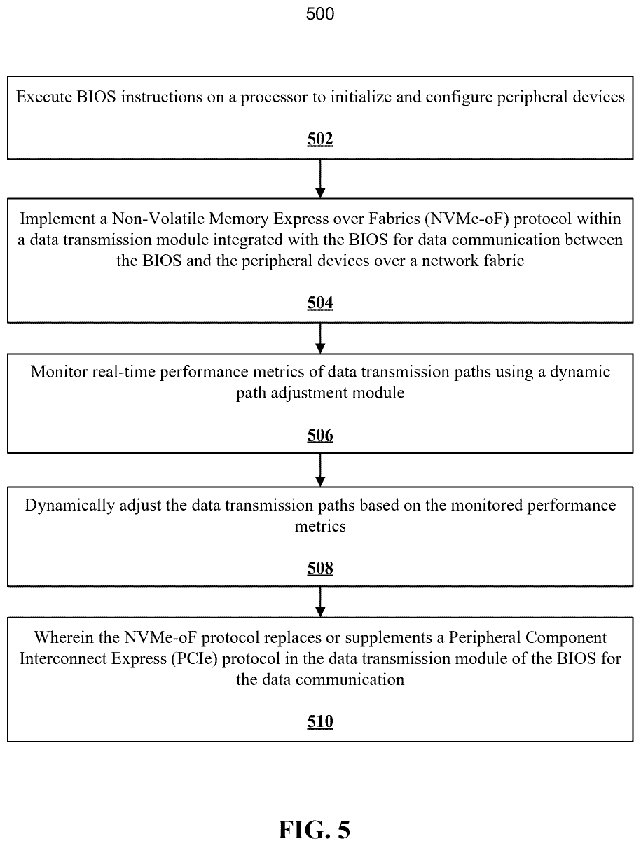

FIG. 5 is a flowchart of an example process 500. In some implementations, one or more process blocks of FIG. 5 may be performed by a device.

As shown in FIG. 5, process 500 includes executing BIOS instructions on a processor to initialize and configure peripheral devices (block 502). For example, a device may execute BIOS instructions on a processor to initialize and configure peripheral devices, as described above.

Process 500 further includes implementing a Non-Volatile Memory Express over Fabrics (NVMe-oF) protocol within a data transmission module integrated with the BIOS for data communication between the BIOS and the peripheral devices over a network fabric (block 504). For instance, a device may implement the NVMe-oF protocol in the data transmission module to facilitate data communication between the BIOS and peripheral devices, as described above.

Additionally, process 500 includes monitoring real-time performance metrics of data transmission paths using a dynamic path adjustment mechanism (block 506). For example, the device may monitor metrics such as bandwidth utilization, transmission latency, and packet loss rates in real-time to assess the health of the data paths.

Process 500 also includes dynamically adjusting the data transmission paths based on the monitored performance metrics (block 508). For example, if performance issues are detected, the device may dynamically reroute data transmission to an alternate path to maintain efficient and reliable communication.

As shown in block 510, the NVMe-oF protocol may replace or supplement a Peripheral Component Interconnect Express (PCIe) protocol in the data transmission module of the BIOS for data communication. For example, the NVMe-oF protocol may be used instead of PCIe to support high-bandwidth, low-latency communication over a network fabric, as described above.

Process 500 may include additional implementations, either independently or in combination with the steps described above. In one implementation, the NVMe-oF protocol employs a Remote Direct Memory Access (RDMA) transport protocol to achieve low-latency and high-bandwidth communication between the BIOS and peripheral devices.

In another implementation, process 500 includes rerouting data transmission to an alternate path in response to detecting performance degradation or faults in the current data transmission path. For instance, if a specific network segment becomes congested or unreliable, the device may automatically switch to a less congested path.

In yet another implementation, process 500 includes feeding historical performance metrics of the data transmission paths to a machine learning model to generate predicted scores for potential performance degradation and executes preventive actions based on these scores.

Preventive actions may include generating alerts to notify maintenance personnel, instructing the addition of redundant devices to high-risk hardware components, or proactively switching high-risk data transmission paths to alternate routes.

In an additional implementation, process 500 includes selecting an optimal data transmission protocol from a predefined set, including the NVMe-oF protocol and the PCIe protocol, based on the performance requirements and operating environment of the peripheral devices.

Another implementation includes performing a bus scan to identify connected hardware devices, such as CPUs, memory, storage devices, and network interface cards. The process may then load appropriate device drivers from firmware based on the identified hardware types and configure operational parameters, such as memory clock frequencies and storage device read/write modes.

In yet another implementation, real-time performance metrics of the data transmission paths may include bandwidth utilization, transmission latency, and packet loss rates. These metrics provide insights into the health and efficiency of the data paths and support dynamic adjustments.

Process 500 may also include loading and executing firmware for peripheral devices using the NVMe-oF protocol during the server startup process, reducing initialization time and ensuring reliable operation.

Finally, process 500 may involve analyzing data transmission paths to identify performance bottlenecks and redundant relay nodes. Using Software-Defined Networking (SDN), the paths can be reconstructed to remove redundant nodes and optimize transmission efficiency.

Although FIG. 5 shows specific blocks of process 500, the process may include additional blocks, fewer blocks, different blocks, or blocks arranged differently than those depicted. Additionally, some blocks may be performed in parallel, depending on the implementation.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. A system for data transmission between a server Basic Input/Output System (BIOS) and peripheral devices, comprising:
a processor configured to execute BIOS instructions stored in a memory;
a data transmission module integrated with the BIOS and preconfigured with a Non-Volatile Memory Express over Fabrics (NVMe-oF) protocol for data communication between the BIOS and the peripheral devices over data transmission paths in a network fabric; and
a dynamic path adjustment module configured to use the NVMe-oF protocol for the data transmission paths, monitor real-time performance metrics of the data transmission paths, and dynamically adjust the data transmission paths,
wherein the data transmission module replaces or supplements a Peripheral Component Interconnect Express (PCIe) protocol with the NVMe-oF protocol for the data communication between the BIOS and the peripheral devices.

2. The system of claim 1, wherein the NVMe-oF protocol comprises a Remote Direct Memory Access (RDMA) transport protocol for low-latency and high-bandwidth communication between the BIOS and peripheral devices.

3. The system of claim 1, wherein the dynamic path adjustment module is further configured to reroute data transmission using an alternate data transmission path in response to detecting a performance degradation or fault in a current data transmission path.

4. The system of claim 1, further comprising a degradation prediction module configured to:
train a machine learning model to learn performance trajectories of the data transmission paths based on historical performance metrics of the data transmission paths.

5. The system of claim 1, further comprising a degradation prediction module configured to:
generate, using a machine learning model, predicted scores for performance degradation of the data transmission paths, wherein the machine learning model is trained to learn performance trajectories of the data transmission paths based on historical performance metrics of the data transmission paths; and
generate preventive actions based on the predicted scores for performance degradation of the data transmission paths to mitigate a risk of data transmission failure.

6. The system of claim 5, wherein the preventive actions comprise generating alert to maintenance personnel, instructing to add backup devices to high-risk hardware components, or proactively switching to alternate data paths.

7. The system of claim 1, wherein the data transmission module is further configured to:
select an optimal data transmission protocol from a set of predefined protocols preconfigured in the data transmission module, comprising the NVMe-oF protocol and the PCIe protocol, based on performance requirements and operating environment of the peripheral devices.

8. The system of claim 1, wherein the BIOS is configured to:
perform a bus scan to identify connected hardware devices, comprising CPUs, memory, storage devices, and network interface cards;
load appropriate device drivers from firmware based on types of the identified hardware devices; and
set operational parameters for the identified hardware devices, comprising memory clock frequencies, and storage device read/write modes.

9. The system of claim 1, wherein the real-time performance metrics of data transmission paths comprise one or more of the following:
bandwidth utilization, transmission latency, and packet loss rates.

10. The system of claim 1, further comprising a firmware loading module configured to load and execute firmware for the peripheral devices using the NVMe-oF protocol during the server startup process.

11. The system of claim 1, wherein the dynamic path adjustment module is further configured to:
analyze the data transmission paths to identify performance bottlenecks and redundant relay nodes; and
reconstruct one or more of the data transmission paths using Software-Defined Networking (SDN) to remove redundant relay nodes.

12. A method for enhancing data transmission efficiency and stability between a server BIOS and peripheral devices, comprising:
executing BIOS instructions on a processor to initialize and configure peripheral devices;
implementing a Non-Volatile Memory Express over Fabrics (NVMe-oF) protocol within a data transmission module integrated with the BIOS for data communication between the BIOS and the peripheral devices over a network fabric;
monitoring real-time performance metrics of data transmission paths using a dynamic path adjustment module; and
dynamically adjusting the data transmission paths based on the monitored performance metrics,
wherein the NVMe-oF protocol replaces or supplements a Peripheral Component Interconnect Express (PCIe) protocol in the data transmission module of the BIOS for the data communication.

13. The method of claim 12, wherein the NVMe-oF protocol uses a Remote Direct Memory Access (RDMA) transport protocol for low-latency and high-bandwidth communication between the BIOS and peripheral devices.

14. The method of claim 12, further comprising:
rerouting the data transmission to an alternate path in response to detecting performance degradation or a fault in a current data transmission path.

15. The method of claim 12, further comprising:
feeding historical performance metrics of the data transmission paths to a trained machine learning model to generate predicted scores for performance degradation of the data transmission paths using the machine learning model; and
executing preventive actions based on the predicted scores to mitigate risks of data transmission failure.

16. The method of claim 15, wherein the preventive actions comprise:
generating alerts to maintenance personnel;
instructing an addition of backup devices to high-risk hardware components; or
proactively switching high-risk data transmission paths to alternate paths.

17. The method of claim 12, further comprising:
selecting an optimal data transmission protocol from a set of predefined protocols, comprising the NVMe-oF protocol and the PCIe protocol, based on performance requirements and operating environment of the peripheral device.

18. The method of claim 12, further comprising:
performing a bus scan to identify connected hardware devices, comprising CPUs, memory, storage devices, and network interface cards;
loading appropriate device drivers from firmware based on types of identified hardware devices; and
setting operational parameters for the identified hardware devices, comprising memory clock frequencies and storage device read/write modes.

19. The method of claim 12, wherein the real-time performance metrics of the data transmission paths comprise one or more of the following:
bandwidth utilization, transmission latency, and packet loss rates.

20. The method of claim 12, further comprising:
analyzing the data transmission paths to identify performance bottlenecks and redundant relay nodes; and
reconstructing the data transmission paths using Software-Defined Networking (SDN) to remove redundant relay nodes and optimize data transmission efficiency.
